(19) United States
(12) Patent Application Publication
(10) Pub. No.: US 2024/0123701 A1
(43) Pub. Date: Apr. 18, 2024

(54) FOLDING APPARATUS FOR FOLDING A CARTON BLANK

(71) Applicant: SOMIC VERPACKUNGSMASCHINEN GMBH & CO. KG, Amerang (DE)

(72) Inventor: Josef Lipp, Ramerberg (DE)

(21) Appl. No.: 18/484,544

(22) Filed: Oct. 11, 2023

(30) Foreign Application Priority Data
Oct. 13, 2022 (EP) 22201261.9

(51) Int. Cl. B31B 50/26; B31B 50/00

(52) U.S. Cl. CPC B31B 50/262; B31B 50/006

(57) ABSTRACT

The invention relates to a folding apparatus for folding a carton blank not belonging to the folding apparatus. The folding apparatus comprises a folding die unit and a folding head unit. According to the invention, the folding die unit comprises two folding die sub-units, each having a substantially U-shaped frame. A plurality of folding tools are disposed on each frame. Furthermore, a base leg of the U-shape of each folding die sub-unit is attached to a separate vertical beam so as to be movable up and down in the height direction. The two U-shaped frames are disposed with the openings of the respective U-shapes facing each other.

### CROSS REFERENCE TO RELATED APPLICATION

This application claims priority to European Patent Application No. 22201261.9, filed in Europe on Oct. 13, 2022, the entire contents of which are hereby incorporated herein by this reference.

### DESCRIPTION

The invention relates to a folding apparatus for folding a carton blank not belonging to the folding apparatus, comprising a folding die unit and a folding head unit, the folding die unit being configured to fold the carton blank around the folding head unit.

Folding die units of known folding apparatuses of the applicant comprise a substantially horizontal U-shaped frame on which a plurality of vertically aligned folding tools are disposed. The base leg of the U-shape is mounted on a vertical beam of the folding apparatus so as to be movable up and down in a height direction in order to be brought together with the folding head unit to fold the carton blank. The vertical beam is, in turn, permanently connected to a machine frame of the machine, in particular a packaging machine, via a transverse beam.

In the case of such folding apparatuses, it has been shown in practice that the side legs of the U-shape tend to deform due not only to their own weight, but also the weight of the folding tools mounted upon them. In particular, the free ends of the side legs tend to sag downwards somewhat and/or be deflected by the counterforces exerted on them by the folding head unit during folding and/or by acceleration forces. In extreme cases, this can lead to the carton blank being folded differently at its two ends.

It is the problem to be solved by the present invention to remedy this situation.

According to the invention, this problem is solved by a folding apparatus of the type mentioned above, in which the folding die unit comprises two folding die sub-units, each of which has a substantially U-shaped frame on which a plurality of folding tools are disposed, with a base leg of the U-shape of each folding die sub-unit being mounted on a separate vertical beam so as to be movable up and down in the height direction, and the two U-shaped frames being disposed with the openings of the respective U-shapes facing each other.

This allows the side legs of the U-shape to be made shorter while folding carton blanks of identical dimensions, thereby significantly increasing their resistance to deformations caused by gravity and/or counterforces and/or acceleration forces. Overall, the folding apparatus according to the invention results in smaller U-shaped frames compared to conventional folding apparatuses for folding carton blanks of identical dimensions.

At this point it should be noted that a U-shaped frame comprises a base leg and two side legs, the side legs being disposed on the base leg substantially parallel to each other. It should also be noted that, in the context of the present invention, a longitudinal direction of the folding apparatus is substantially parallel to the direction in which the undeformed side legs of the U-shape extend, and a transverse direction of the folding apparatus is substantially parallel to the direction in which the base leg of the U-shape extends.

To be able to further reduce the length of the side legs, a predefined distance can be provided between the free ends of side legs of the two frames. This allows the side legs to have a length that is smaller than half the distance between the two base legs of the U-shapes of the frames. Since this distance between the two base legs has a direct influence on the longitudinal dimension of the largest carton blanks that can be folded by the folding apparatus, this can further increase the stability of the side legs.

However, this measure can also be used to adjust the range of formats that can be processed by the folding apparatus. For example, if the folding apparatus was originally set up for carton blanks with a length in a range of 0 mm to 300 mm, it can easily be converted to a range of, for example, 300 mm to 600 mm by, for example, moving one of the folding die sub-units on the machine frame by 300 mm, which also increases the distance between the free ends of the side legs of the two frames by this 300 mm.

In order to make the folding apparatus according to the invention as short as possible in the longitudinal direction despite the provision of two folding die sub-units, it is proposed in a further development of the invention that at least one drive motor, which is provided in order to move the frame of at least one of the folding die sub-units in the height direction, is disposed at least partially, preferably completely, within the longitudinal extent of the vertical beam of the associated folding die sub-unit. Motors with a rotating drive shaft, for example electric motors, but also fluidically, in particular pneumatically and/or hydraulically, driven rotary motors, as well as linear motors, for example electromagnetically operating linear motors, but also fluidically, in particular pneumatically and/or hydraulically, driven linear motors, for example pneumatic and/or hydraulic cylinders, can be considered as drive motors.

In the case of motors with a rotating drive shaft, it may also be provided in a further development of the invention that the axis of rotation of the at least one drive motor is disposed transversely to the longitudinal direction of the folding apparatus. Preferably, each of the folding die sub-units is assigned its own transversely disposed drive motor.

The overall length of the folding apparatus can be further reduced if, in at least one of the folding die sub-units, a transverse beam, which serves to attach the folding die sub-unit to a machine frame not belonging to the folding apparatus, is connected to the vertical beam so as to form a structural unit. This saves the overall length required for a separate transverse beam.

To facilitate format changes, it is proposed that side legs of at least one folding die sub-unit are configured so as to be adjustable in the transverse direction. Adjustment of the side legs can advantageously be carried out synchronously and symmetrically relative to a longitudinal median plane of the folding apparatus. To enable an automated format change, the adjustment can also be motorised, for example by electric motor.

In addition or alternatively, to facilitate a format change, it can further be provided that at least one folding tool of at least one folding die sub-unit is configured so as to be adjustable in the longitudinal direction. To enable an automated format change, the adjustment can advantageously be motorised, for example by electric motor.

With the folding apparatus according to the invention it is also conceivable in principle that each side leg of the U-frame of the folding die sub-units supports more than one folding tool. According to the invention, however, it is provided that each side leg of the U-frames of the folding die sub-units supports exactly one folding tool. If it is required or desired that the folding tool should engage with the carton blank at more than one location, this can be achieved, for example, by at least one folding tool having more than one engagement portion adapted to engage with the carton blank for folding.

Different operating modes can be realised with the folding apparatus according to the invention. For example, it may be provided that the folding apparatus comprises a control device which is adapted to selectively control the drive motors of the two folding die sub-units synchronously and in the same direction according to a first operating mode, or independently of each other according to a second operating mode. The first operating mode corresponds to the normal operation of the folding apparatus. However, with very small cartons, it may be possible to fold a carton using one of the folding die sub-units alone. In this case it is possible to have the folding apparatus work in double cycle, that is to say, to process two carton blanks at the same time, one in each of the two folding die sub-units. The capacity of the folding apparatus can be doubled in this way.

In order to fold both straight and angled trays (folding cartons) with the folding apparatus according to the invention, it may further be provided for the first operating mode that the control device is configured to control the drive motors of the two folding die sub-units according to a first sub-mode of the first operating mode to produce an identical stroke amplitude of the two frames, or according to a second sub-mode of the first operating mode to produce a different stroke amplitude of the two frames.

To make it easy to adjust the folding die sub-units, it is proposed in a further development of the invention that a transverse beam has, at each of its transverse ends, two attachment points spaced apart from each other in the longitudinal direction and adapted to engage with a machine frame not belonging to the folding apparatus, one of the attachment points being configured eccentrically about an axis running in the transverse direction. By simply turning the eccentrically designed attachment point, the vertical beam can thus be brought, for example, into a position running exactly in the vertical direction.

The transverse beam may also be connected to the vertical beam to form a structural unit.

The invention is explained in more detail below based on exemplary embodiments with reference to the accompanying drawings.

These show the following:

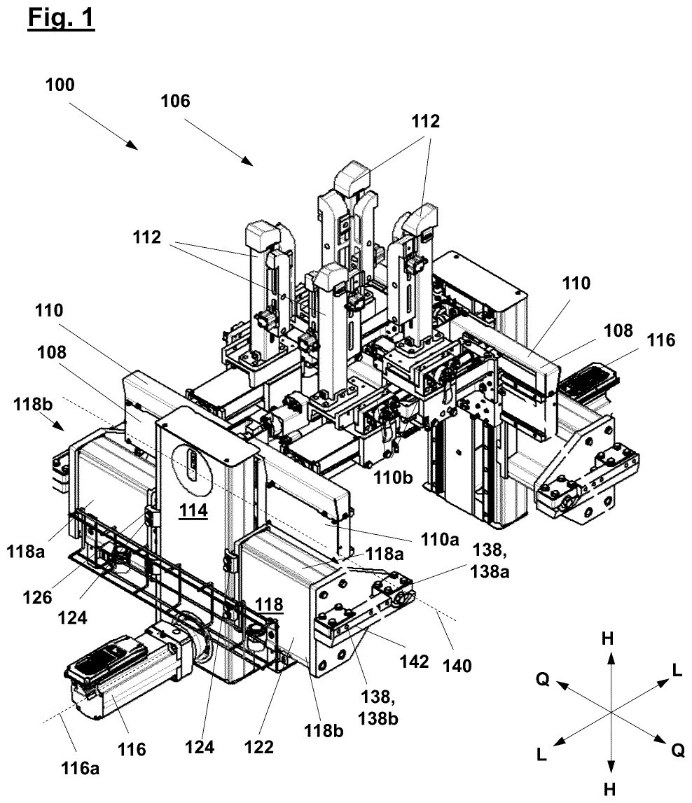

FIG. 1 a perspective view of a folding apparatus according to a first embodiment,

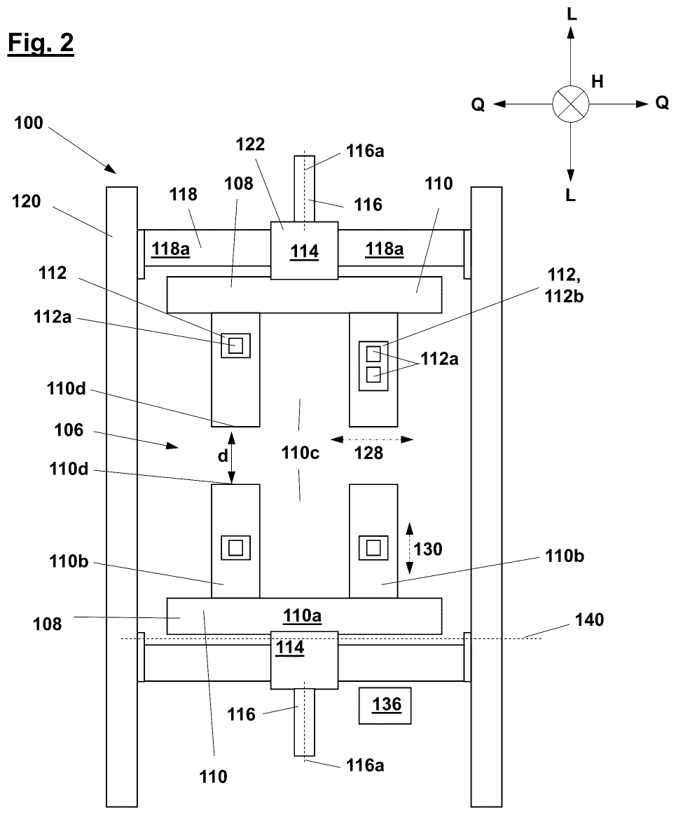

FIG. 2 a schematic plan view of the folding apparatus according to the first embodiment,

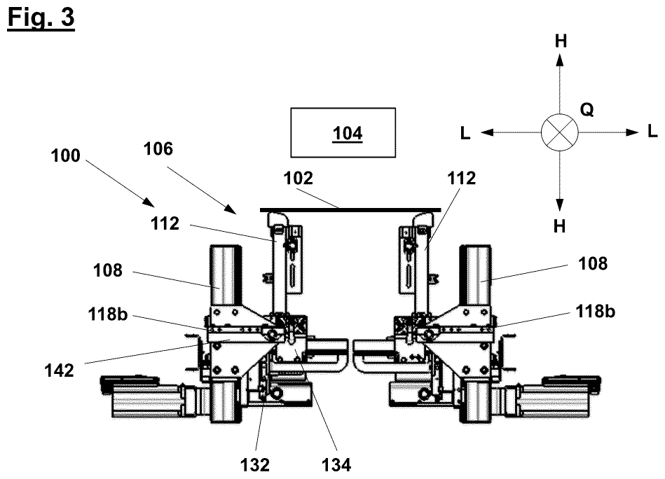

FIG. 3 a side view of the folding apparatus shown in FIG. 1, and

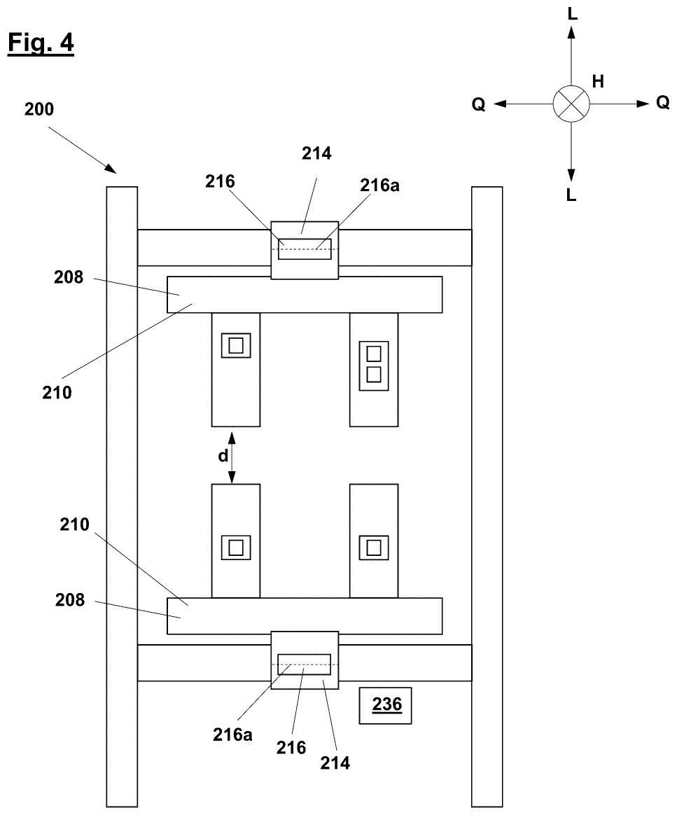

FIG. 4 a schematic plan view of a folding apparatus according to a second embodiment.

In FIG. 1, a first embodiment of a folding apparatus is generally designated with the reference sign 100. The folding apparatus 100 is intended to fold a carton blank 102.

For this purpose, the folding apparatus 100 comprises a folding head unit 104, which is only roughly schematically illustrated in FIG. 3, and a folding die unit 106, which is adapted to fold the carton blank 102 around the folding head unit 104. According to the invention, the folding die unit 106 comprises two folding die sub-units 108, each having a substantially U-shaped frame 110. A plurality of folding tools 112 are disposed on the substantially U-shaped frame 110 of each folding die sub-unit 108.

The U-shaped frame 110 comprises a base leg 110a and two side legs 110b, the side legs 110b extending from the base leg 110a substantially parallel to each other. The base leg 110a of the U-shape of each folding die sub-unit 108 is attached to a vertical beam 114 so as to be movable up and down in the height direction H.

At this point it should be noted that the folding apparatus 100 extends in a longitudinal direction L, a transverse direction Q and the height direction H, running orthogonally to each other in pairs. The longitudinal direction L is substantially parallel to the direction in which the undeformed side legs 110b extend and the transverse direction Q is substantially parallel to the direction in which the base leg 110a of the U-shaped frame 110 extends, as shown in the plan view of the folding apparatus 100 in FIG. 2.

Each of the two substantially U-shaped frames 110 also has an opening 110c (see FIG. 2). In the folding apparatus 100 according to the invention, the openings 110c of the respective U-shapes of the two frames 110 are disposed so that they face each other. Consequently, the free ends 110d of the side legs 110b of the frames 110 of the two folding die sub-units 108 also face each other.

Furthermore, the free ends 110d of the side legs 110b are disposed opposite each other, being at a predefined distance d from each other. This distance d correlates with a minimum distance always present between the folding tools 112 in operation. This makes it possible to further reduce the length of the side legs 110b.

The folding apparatus 100 can also be converted to a different range of formats by changing the distance d. For this purpose, for example, at least one of the folding die sub-units 108 can be moved away from or towards the respective other folding die sub-unit 108 in the longitudinal direction L.

The folding apparatus 100 further comprises at least one drive motor 116 which is provided to cause the movement of the frame 110 of at least one of the folding matrix sub-units 108 in the height direction H. In the embodiment shown, a separate drive motor 116 is assigned to each of the folding die sub-units 108. The drive motors 116 each have an axis of rotation 116a. In the exemplary embodiment shown in FIGS. 1 to 3, the axis of rotation 116a runs parallel to the longitudinal direction L of the folding apparatus 100.

FIG. 4 shows a folding apparatus 200 according to a second embodiment which substantially corresponds to the folding apparatus 100 according to the first embodiment. Therefore, in FIG. 4 the same components are designated with the same reference signs as in FIGS. 1 to 3, but increased by 100. Furthermore, the folding apparatus 200 is described below only with regard to its differences compared to the folding apparatus 100, whose description is otherwise expressly referred to herein.

The folding apparatus 200 also has at least one drive motor 216 which is provided to cause the movement of the U-shaped frame 210 of at least one of the folding die sub-units 208 in the height direction H. In the folding apparatus 200, too, a separate drive motor 216 is assigned to each of the folding die sub-units 208. In contrast to the embodiment of FIGS. 1 to 3, however, the axis of rotation 216a of the drive motors 216 runs orthogonally to the longitudinal direction L of the folding apparatus 200, in particular in the transverse direction Q. This embodiment can also help to keep the longitudinal extent of the folding apparatus 200 as short as possible. To the same end, the two drive motors 216 are disposed at least partially within the longitudinal extent of a vertical beam 214 of the associated folding die sub-unit 208. In particular, at least one of the drive motors 216 may be disposed entirely within the longitudinal extent of the vertical beam 214.

Referring again to FIGS. 1 to 3, a transverse beam 118 extends in the transverse direction Q adjacent to a vertical beam 114 of a folding die sub-unit 108. The folding die sub-unit 108 is fastened to a machine frame 120 via the transverse beam 118.

According to the invention, the transverse beam 118 can be connected to the vertical beam 114 to form a structural unit 122, thereby allowing the overall length of the folding apparatus 100 in the longitudinal direction L to be further shortened. For example, the transverse beam 118 can be divided into two transverse beam portions 118a which receive the vertical beam 114 between them. The two transverse beam portions 118a are preferably disposed so that the vertical beam 114 can be disposed centrally between the two transverse beam sections 118a in the transverse direction Q and thus centrally within the machine frame 120.

The vertical beam 114 and the transverse beam sections 118a can, for example, be welded together. Alternatively, they can also be removably attached to each other. For this purpose, the structural unit 122 may comprise connecting elements 124 by means of which the vertical beam 114 is connected to the transverse beams 118. These connecting elements 124 can, for example, be clamping elements tensioned by bolts 126 that engage in clamping grooves of the vertical beam 114 and transverse beam 118. Such a clamp connection allows the vertical beam 114 to be moved relative to the transverse beam 118 in the vertical direction without having to drill new mounting holes, for example.

To be able to fold carton blanks 102 with different formats, in particular widths, using the same folding apparatus 100 and to facilitate this format change, the side legs 110b of at least one folding die sub-unit 108 are configured so as to be adjustable in the transverse direction Q, as exemplified for a side leg 110b by a dashed arrow 128 in FIG. 2. FIG. 2 also shows by means of a dashed arrow 130 that at least one folding tool 112 can be disposed so as to be adjustable in the longitudinal direction L.

Both the adjustment of a side leg 110b, preferably both side legs 110b, of a U-shaped frame 110 of a folding die sub-unit 108 in the transverse direction Q and the adjustment of a folding tool 112 in the longitudinal direction L on a side leg 110b can be performed by a motor, for example an electric motor. For this purpose, a side leg adjustment unit 132 or a folding tool adjustment unit 134 can be provided (see FIG. 3). Format changes can be further facilitated in this way.

Although in principle it is possible for each side leg to carry more than one folding tool, it is preferred according to the invention that each side leg 110b of the U-shaped frames 110 of the folding die sub-units 108 of the discussed first embodiment carries exactly one folding tool 112, which can extend in the height direction H. Each folding tool 112 can have at least one engagement portion 112a which is adapted to engage with the carton blank 102 for folding. However, if it is required or desired that the folding tool 112 should engage with the carton blank 102 at more than one location, at least one folding tool 112b may have more than one engagement portion 112a. In FIG. 2, the folding tool 112b is provided with two engagement portions 112a by way of example.

The folding apparatus 100 also includes a control device 136, which is only shown schematically in FIG. 2. An analogous control device 236 may also be provided in the embodiment of FIG. 4.

The control device 136 is configured to selectively control the drive motors 116 of the two folding die sub-units 108 according to a first operating mode or according to a second operating mode. In the first operating mode the control device 136 controls the drive motors 116 synchronously and in the same direction, whereas in the second operating mode the drive motors 116 of the frames 110 of the two folding die sub-units 108 are controlled independently of each other. The first operating mode corresponds to the normal operation of the folding apparatus. However, with very small cartons, it may be possible to fold a carton using one of the folding die sub-units alone. In this case it is possible to have the folding apparatus work in double cycle, that is to say, to process two carton blanks at the same time, one in each of the two folding die sub-units. The capacity of the folding apparatus can be doubled in this way.

The control device 136 may further control the drive motors 116 of the two folding die sub-units 108 in the first operating mode according to a first sub-mode or according to a second sub-mode. In the first sub-mode of the first operating mode, the control device 136 controls the drive motors 116 of the two folding die sub-units 108 such that the frames 110 of the two folding die sub-units 108 performs an identical stroke amplitude in the height direction H synchronously and in the same direction. In the second sub-mode of the first operating mode, the control device 136 controls the drive motors 116 of the two folding die sub-units 108 so that the two frames 110 move in the same height direction H but with different stroke amplitudes. This allows angled trays as well as straight trays to be folded from corresponding carton blanks 102.

During the folding process, the control device 136 controls the drive motors 116 such that the U-shaped frame 110 moves up and down the vertical beam 114 with a predefined stroke amplitude in the height direction H. The folding tools 112 provided on the side legs 110b thus also move in the height direction H towards the folding head unit 104 until the at least one engagement portion 112a engages with the carton blank 102. The U-shaped frame 110 then continues to move until the predefined stroke amplitude is reached and folds the carton blank around the folding head unit 104 into the desired carton shape. While the U-shaped frame 110 moves away from the folding head unit 104 in the height direction H, the folded carton is transported out of the folding apparatus 100 in a known manner and a new carton blank 102 is fed to the folding apparatus 100.

For attachment to the associated machine frame 120, the transverse beam 118 has two attachment points 138 spaced apart from each other in the longitudinal direction L at each of its transverse ends 118b, which can engage with the machine frame 120 to connect the transverse beam 118 to the machine frame 120. One of the attachment points 138a is configured eccentrically about an axis 140 running in the transverse direction Q. When the two fastening points 138a and 138b engage with the machine frame 120, the eccentrically configured fastening element 138a can be rotated to bring the transverse beam 118 and/or components attached to it, for example the vertical beam 114, into a desired, for example exactly vertical, position. For easy operation of the eccentrically configured fastening point 138a, a rotary element 142, for example a rotary knob, can be provided at the eccentrically designed fastening point 138a.

1. Folding apparatus for folding a carton blank not belonging to the folding apparatus, the folding carton comprising:
a folding die unit; and
a folding head unit,
wherein the folding die unit is configured to fold the carton blank around the folding head unit,
wherein the folding die unit comprises two folding die sub-units, each having a substantially U-shaped frame on which a plurality of folding tools are disposed, wherein the U-shaped frame comprises a base leg and two side legs,
the base leg of the U-shaped frame of each folding die sub-unit being attached to a separate vertical beam so as to be movable up and down in a height direction, and
the U-shaped frames being disposed with openings of the respective U-shaped frames facing each other,
wherein at least two drive motor, which are provided to cause the movement of the frame of at least one of the folding die sub-units in the height direction, are disposed at least partially within a longitudinal extent of the vertical beam of the associated folding die sub-unit, and
wherein the folding apparatus comprises a control device which is configured to selectively control the drive motors of the two folding die sub-units synchronously and in the same direction according to a first operating mode, or independently of each other according to a second operating mode.

2. Folding apparatus according to claim 1,
wherein a predefined distance is provided between free ends of the side legs of the two frames.

3. Folding apparatus according to claim 1,
wherein an axis of rotation of at least one drive motor is disposed transversely to a longitudinal direction of the folding apparatus.

4. Folding apparatus according to claim 1,
wherein, in at least one of the folding die sub-units, a transverse beam, which serves to fasten the folding die sub-unit to a machine frame not belonging to the folding apparatus, is connected to the vertical beam so as to form a structural unit.

5. Folding apparatus according to claim 1,
wherein the side legs of at least one folding die sub-unit are configured so as to be adjustable in a transverse direction.

6. Folding apparatus according to claim 1,
wherein at least one folding tool of at least one folding die sub-unit is configured so as to be adjustable in a longitudinal direction.

7. Folding apparatus according to claim 1,
wherein each side leg of the frames of the folding die sub-units carries exactly one folding tool.

8. Folding apparatus according to claim 1,
wherein at least one folding tool has more than one engagement portion adapted to engage with the carton blank for folding.

9. Folding apparatus according to claim 1,
wherein the control device is configured to control the drive motors of the two folding die sub-units according to a first sub-mode of the first operating mode to produce an identical stroke amplitude of the two frames, or according to a second sub-mode of the first operating mode to produce a different stroke amplitude of the U-shaped frames.

10. Folding apparatus according to claim 1,
wherein a transverse beam has, at each of its transverse ends, two attachment points spaced apart from each other in a longitudinal direction and adapted to engage with a machine frame not belonging to the folding apparatus, one of the attachment points being designed eccentrically about an axis extending in a transverse direction.

11. Folding apparatus for folding a carton blank not belonging to the folding apparatus, the folding apparatus comprising:
a folding die unit; and
a folding head unit,
wherein the folding die unit is configured to fold the carton blank around the folding head unit,
wherein the folding die unit comprises two folding die sub-units, each having a substantially U-shaped frame on which a plurality of folding tools are disposed,
a base leg of the U-shaped frame of each folding die sub-unit being attached to a separate vertical beam so as to be movable up and down in a height direction, and
the U-shaped frames being disposed with openings of the respective U-shaped frames facing each other.

12. Folding apparatus according to claim 11,
wherein a predefined distance is provided between the free ends of side legs of the U-shaped frames.

13. Folding apparatus according to claim 11,
wherein at least one drive motor, which is provided to cause the movement of the frame of at least one of the folding die sub-units in the height direction, is disposed at least partially within a longitudinal extent of the vertical beam of the associated folding die sub-unit.

14. Folding apparatus according to claim 12,
wherein an axis of rotation of at least one or of the at least one drive motor is disposed transversely to a longitudinal direction of the folding apparatus.

15. Folding apparatus according to claim 12,
wherein, in at least one of the folding die sub-units, a transverse beam, which serves to fasten the folding die sub-unit to a machine frame not belonging to the folding apparatus, is connected to the vertical beam so as to form a structural unit.

16. Folding apparatus according to claim 11,
wherein side legs of at least one folding die sub-unit are configured so as to be adjustable in a transverse direction.

17. Folding apparatus according to claim 11,
wherein at least one folding tool of at least one folding die sub-unit is configured so as to be adjustable in a longitudinal direction.

18. Folding apparatus according to claim 1,
wherein each side leg of the frames of the folding die sub-units carries exactly one folding tool.

19. Folding apparatus according to claim 11
wherein at least one folding tool has more than one engagement portion adapted to engage with the carton blank for folding.

20. Folding apparatus according to claim 13,
wherein the folding apparatus comprises a control device which is configured to selectively control the drive motors of the two folding die sub-units and in the same direction according to a first operating mode, or independently of each other according to a second operating mode.

21. Folding apparatus according to claim 20,
wherein the control device is configured to control the drive motors of the two folding die sub-units according to a first sub-mode of the first operating mode to produce an identical stroke amplitude of the two frames, or according to a second sub-mode of the first operating mode to produce a different stroke amplitude of the two frames.

22. Folding apparatus according to claim 11,
wherein a transverse beam has, at each of its transverse ends, two attachment points spaced apart from each other in a longitudinal direction and adapted to engage with a machine frame not belonging to the folding apparatus, one of the attachment points being designed eccentrically about an axis extending in a transverse direction.
